(19) United States
(12) Patent Application Publication
(10) Pub. No.: US 2014/0372882 A1
(43) Pub. Date: Dec. 18, 2014

(54) REMOTE CONTROL OF IMAGING DEVICES USING RETRIEVED PREVIEW IMAGES

(71) Applicant: CSR Imaging US, LP, Burlington, MA (US)

(72) Inventors: Ericsson Bushnell Broadbent, III, Harvard, MA (US); Luis Enrique Garcia Ugarriza, San Diego, CA (US); Mark Haines Goldwater, Lexington, MA (US); Bruce Alan Mallett, Windham, NH (US); Matthew Howard Schreiner, Cambridge, MA (US)

(21) Appl. No.: 13/921,039

(22) Filed: Jun. 18, 2013

(51) Int. Cl. G06F 17/21

(52) U.S. Cl. CPC G06F 17/212
USPC 715/274

(57) ABSTRACT

Embodiments are directed towards providing a user of a remote device access to the capabilities of an imaging device by employing preview images. An image of a document may be generated at the imaging device, wherein the imaging device is enabled to print, fax, project, display, or otherwise present a representation of the image. A preview image of the image may be generated at the imaging device. The preview image may be provided to the remote control device. The preview image may be displayed at the remote device. Available imaging device commands, based on an attribute of the document may be provided to and displayed at the remote device. A user of the remote device may be enabled to selectively activate an available imaging device command. An imaging device command activated at the remote device may be provided to the imaging device. The imaging device may perform the provided imaging device command. The image may be updated. The updated image may be printed, faxed, projected, displayed, or otherwise presented. The preview image may be updated. The updated preview image may be provided to the remote device.

### TECHNICAL FIELD

The present invention relates generally to remote control of imaging devices, and more particularly, but not exclusively, to providing preview images to a remote device and enabling a user of the remote device to view the preview images and access the capabilities of the imaging device in real time and in response to the preview images.

### BACKGROUND

With the advent of ubiquitous computing, graphical user interfaces, and multimedia data exchange in business, arts, and personal use, efficient and high-quality processing, printing, projecting, and displaying of documents and images have become increasingly important. Network-connected imaging devices may receive documents to be printed, projected, or otherwise displayed from various sources such as job queues, security queues, document management systems, built-in storage, digital cameras, removable mass storage devices, network computing devices, mobile devices, and the like. These imaging devices may include printers, projectors, and monitors.

In addition to capabilities such as printing, projecting, and displaying, these imaging devices may include other capabilities that modify or affect the printing, projecting, or displaying of documents. For example, these other capabilities may include adding a watermark or page numbers to a document to be printed. Abilities to remotely access these and other capabilities of imaging devices are currently limited. Thus, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 illustrates a system environment in which various embodiments may be implemented;

FIG. 2 shows an imaging device that may be included in various embodiments;

FIG. 3 shows a client device that may be included in various embodiments;

FIG. 4 illustrates a logical flow diagram generally showing one embodiment of an overview process for remotely controlling imaging devices using preview images;

FIG. 5 illustrates a logical flow diagram generally showing one embodiment of a process for employing an imaging device to generate a preview image;

FIG. 6 illustrates a logical flow diagram generally showing one embodiment of a process for employing an imaging device to provide a preview image and available command to a remote control device;

FIG. 7 illustrates a logical flow diagram generally showing one embodiment of a process for employing a remote device to provide an activated imaging device command to an imaging device;

FIG. 8 illustrates a logical flow diagram generally showing one embodiment of a process for employing an imaging device to perform a provided imaging device command; and

FIG. 9 illustrates a logical flow diagram generally showing one embodiment of a process for remotely controlling imaging devices employing preview images;

### DETAILED DESCRIPTION

Various embodiments now will be described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

The term “imaging device” as used herein may include any device that is enabled to print, fax, project, display, or otherwise present a representation of a documents or an image of a document. In at least one of various embodiments, an imaging device may include one or more printers, multi-function printers (MFP), color printers, projectors, video projectors, smartboards, monitors, television terminals, mobile devices, faxes, or any device that may be enabled to print, fax, project, display, or otherwise present a representation of document or an image of a document.

The term “document” as used herein may include any set of information. In at least one the various embodiments, a document may include a file. In at least one of the various embodiments, a document may include a computer readable file. Non-exhaustive and non-limiting examples of documents may include text documents, word processing documents, presentation documents, such as slides, spreadsheet documents, database documents, email messages, image, graphics, illustrative and/or picture documents, e-books, web pages, source code files, and the like. A document may include one or more pages.

The following briefly describes embodiments in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed towards providing remote operation of an imaging device that generates a presentation of an image of a provided document. In at least one of the various embodiments, the imaging device may generate an image of the provided document. The imaging device may be enabled to print, fax, project, display, or otherwise present a representation of the generated image. A preview image of the image may also be generated at the imaging device. In at least one embodiment, the preview image may be provided to a remote control device that is operative to display the preview image. The remote control device is further arranged to display at least one available command for remotely operating the image device's presentation of the image. Each available imaging device command at the remote control device may correspond to at least one capability of the imaging device to present the image. Also, in at least one embodiment, each available device command may further correspond to at least one attribute of the document and/or image.

In at least one of the various embodiments, an available command, such as an imaging device command, selectively activated at the remote control device may be provided to the imaging device. A user of the remote control device may activate the imaging device command. The activated imaging device command may be performed at the imaging device. In some embodiments, the image may be updated in response to performing the imaging device command. The updated image may be printed, faxed, projected, displayed, or otherwise presented at the imaging device in response to performing the imaging device command. In some embodiments, the preview image may be updated in response to performing the imaging device command. In some embodiments, the updated preview image may be provided to the remote control device in response to performing the imaging device command. In at least one embodiment, a document may be updated in response to performing the imaging device command. In at least one of the various embodiments, the generated preview image may be a thumbnail image of the image. In at least one embodiment, the user of the remote control device may view the displayed preview image within a graphical user interface (GUI) at the remote control device. The user may activate an available imaging device command by interacting with the GUI.

In at least one embodiment, the user may be able to remotely access capabilities of the imaging device by at least selectively activating imaging device commands. In at least one embodiment, the imaging device capabilities that a user may be enabled to remotely access by activating imaging device commands include, but are not limited to printing the image, projecting the image, faxing the image, displaying the image, or otherwise presenting the image. The imaging device capabilities that a user may be enabled to remotely access by activating imaging device commands may also include, but are not limited to updating an image by adding a watermark or header/footer/page number information to the image, rearranging a presentation order of multiple images, highlighting text included in an image, adding a bullet point to an portion of an image, and color correcting an image.

The image and preview image of the image may be generated at the imaging device, but the user may view the preview image of the image at the remote control device. Therefore, the remote control device is not required to generate, access, read, update, modify, or display the image or document to be printed, faxed, projected, displayed, or otherwise presented. Thus, the present invention mitigates document or image compatibility issues between the imaging device and the remote control device.

Furthermore, the user may activate an imaging device command at the remote control device, where the imaging device command corresponds to at least one capability of the imaging device. However, the activated imaging device command may be provided to and performed at the imaging device. Therefore, the present invention allows a user to remotely access any capability of the imaging device, but the remote control device need not be enabled with any particular imaging device capability. Thus, the present invention mitigates imaging device and remote control device inter-operability issues while simultaneously minimizing the resources, such as memory, CPU cycles, storage, or power, utilized at the remote control device. Additionally, because the image or the updated image to be printed, faxed, projected, displayed, or otherwise presented is not required to be provided to the remote control device, the utilization of network resources, such as bandwidth, is minimized.

In at least some embodiments, the client device may be a remote device, such as a remote control device. In at least one of various embodiments, the remote control device may be a special purpose computing device with embedded firmware or hardware, a mobile device running special purpose application software, a desktop computing device, a notebook computing device, a tablet computing device, or any other such device. In at least one embodiment, an imaging device, such as a printer, projector, fax device, monitor, or any other such device that is enabled to print, fax, project, displayed, or otherwise present an image, may be enabled to provide data or other information to the remote control device through a wired or wireless network. The remote control device may be enabled to provide data or other information to the imaging device through the network, or through at least one other network. At least one preview image may be utilized, where the remote control device is provided the at least one preview image for display. In at least one embodiment, a secure session for communication is established between the imaging device and the remote device.

### Illustrative Operating Environment

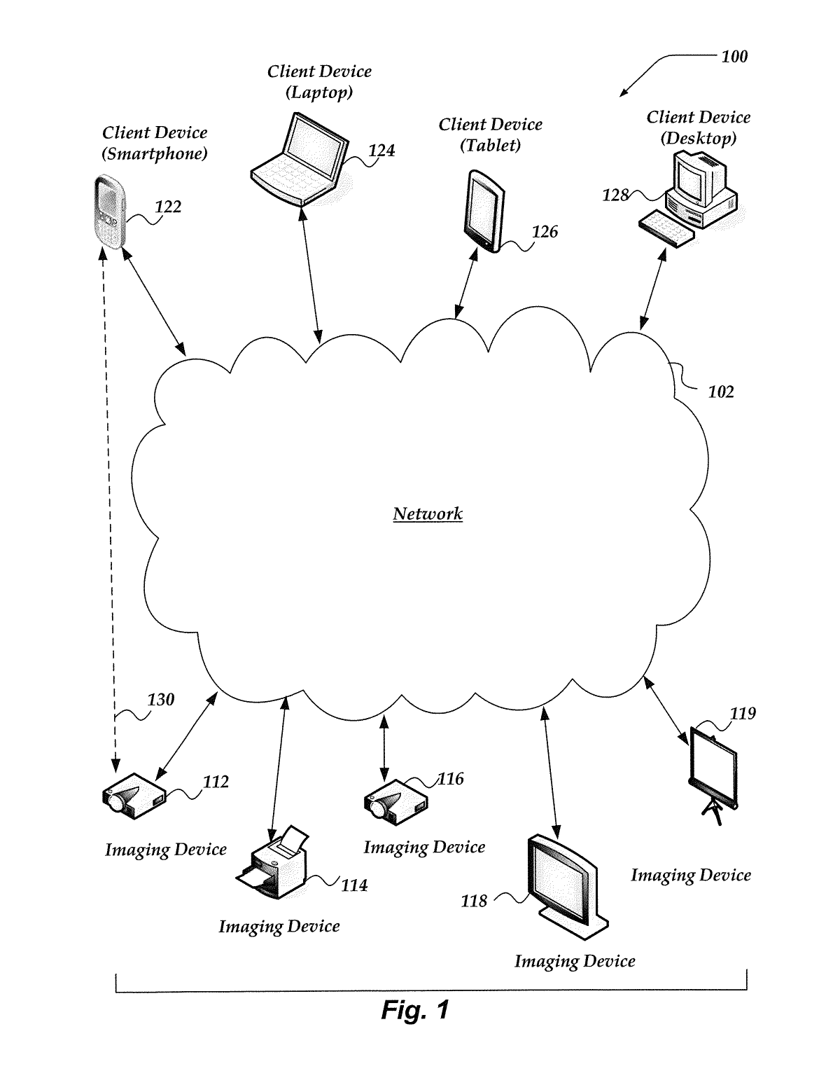

FIG. 1 shows components of an environment in which various embodiments may be practiced. Not all of the components may be required to practice the various embodiments, and variations in the arrangement and type of the components may be made without departing from the spirit or scope of the various embodiments.

In at least one embodiment, cloud network 102 enables one or more network services for a user based on the operation of virtually any type of networked computing device. Although not shown, one or more client devices may be included in cloud network 102 in one or more arrangements to provide one or more network services to a user. Also, these arrangements of networked computing devices may or may not be mutually exclusive of each other.

Additionally, the user may employ a plurality of virtually any type of wired or wireless networked computing devices to communicate with cloud network 102 and access at least one of the network services. These networked computing devices may include tablet client device 126, handheld client device 122, laptop client device 126, desktop client device 120, and the like. Although not shown, in various embodiments, the user may also employ notebook computers, microprocessor-based or programmable consumer electronics, network appliances, mobile telephones, smart telephones, pagers, radio frequency (RF) devices, infrared (IR) devices, Personal Digital Assistants (PDAs), televisions, integrated devices combining at least one of the preceding devices, and the like.

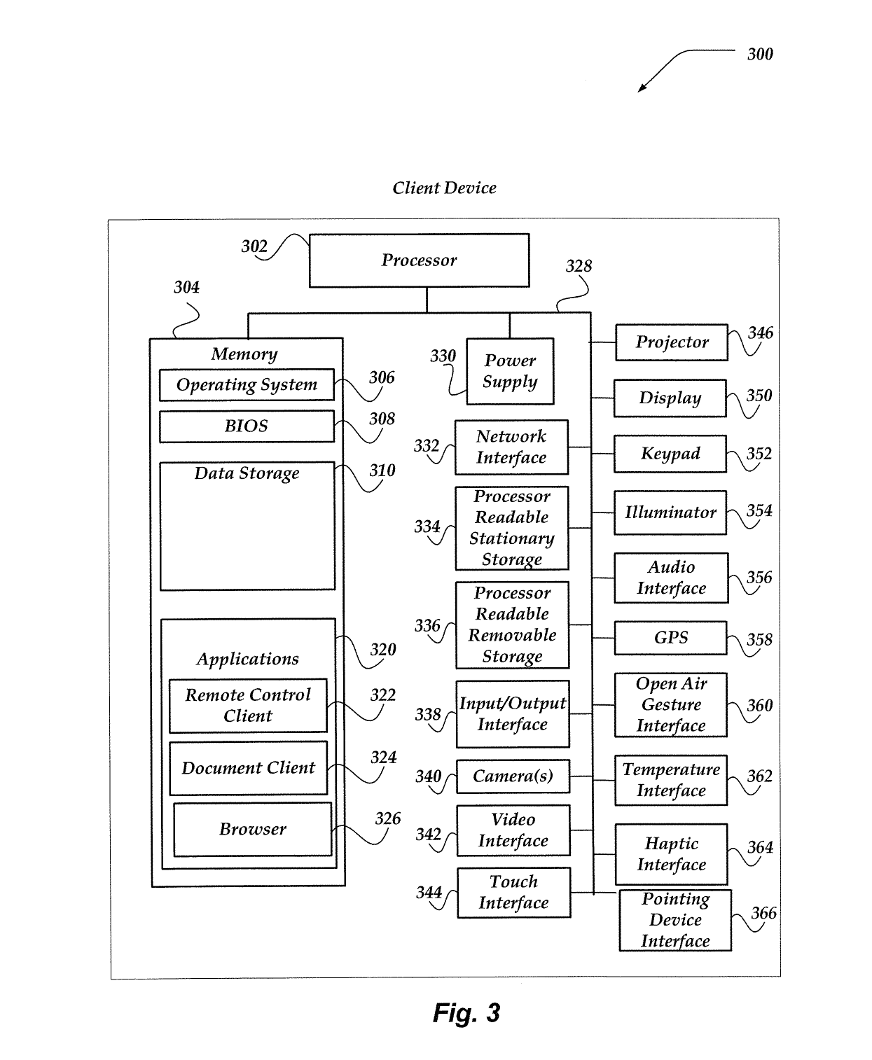

One embodiment of a client device is described in more detail below in conjunction with FIG. 3. Generally, client devices may include virtually any substantially portable, or non-portable, networked computing device capable of communicating over a wired, wireless, or some combination of wired and wireless network.

Through the use of a client device 122-128, a user may remotely access all of the capabilities of each one of a plurality of imaging devices 112-119, connected to the cloud network 102. The networked imaging devices may include projector device 112, printer device 114, another projector device 116, monitor device 118, smartboard device 119, fax device, and the like. Although not shown, in various embodiments, imaging devices may include multi-function printers (MFP), color printers, or any device capable of printing, projecting, displaying, or otherwise imaging an image.

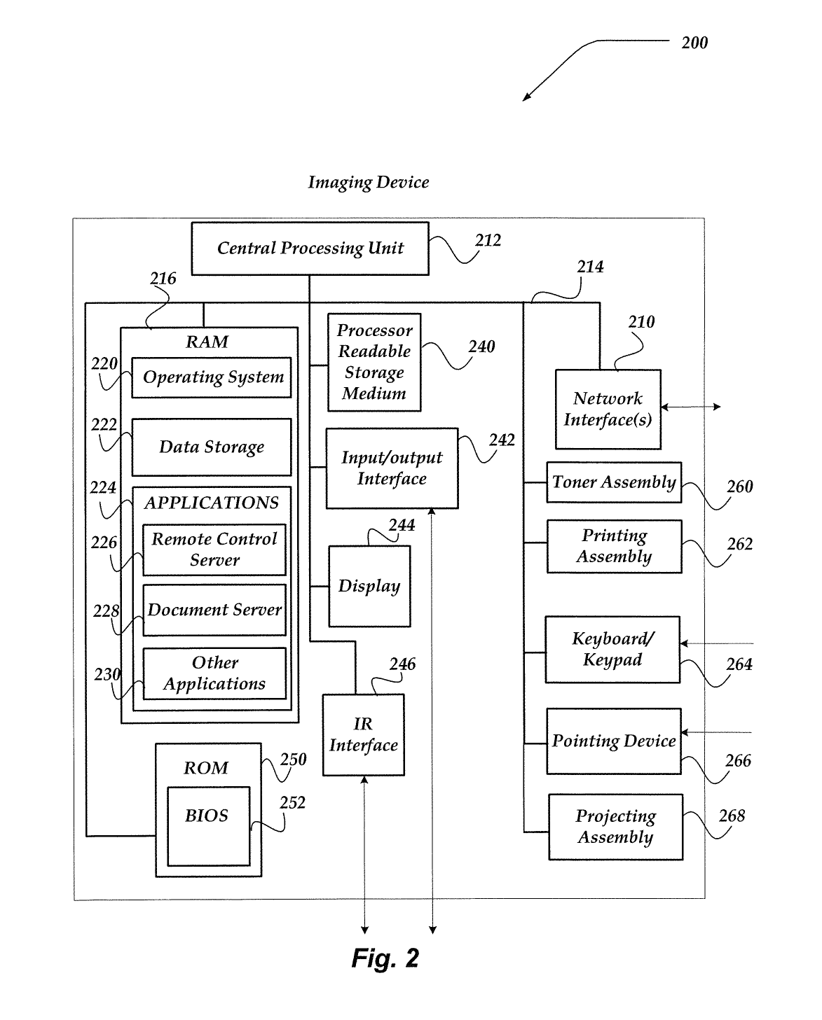

One embodiment of an imaging device is described in more detail below in conjunction with FIG. 2. Generally, imaging devices may include virtually any substantially portable, or non-portable, networked computing device capable of imaging and image and communicating over a wired, wireless, or some combination of wired and wireless network.

In various embodiments, network 102 may employ virtually any form of communication technology and topology. For example, network 102 can include local area networks Personal Area Networks (PANs), (LANs), Campus Area Networks (CANs), Metropolitan Area Networks (MANs) Wide Area Networks (WANs), direct communication connections, and the like, or any combination thereof. On an interconnected set of LANs, including those based on differing architectures and protocols, a router acts as a link between LANs, enabling messages to be sent from one to another. In addition, communication links within networks may include virtually any type of link, e.g., twisted wire pair lines, optical fibers, open air lasers or coaxial cable, plain old telephone service (POTS), wave guides, acoustic, full or fractional dedicated digital communication lines including T1, T2, T3, and T4, and/or other carrier and other wired media and wireless media. These carrier mechanisms may include E-carriers, Integrated Services Digital Networks (ISDNs), universal serial bus (USB) ports, Firewire ports, Thunderbolt ports, Digital Subscriber Lines (DSLs), wireless links including satellite links, or other communications links known to those skilled in the art. Moreover, these communication links may further employ any of a variety of digital signaling technologies, including without limit, for example, DS-0, DS-1, DS-2, DS-3, DS-4, OC-3, OC-12, OC-48, or the like. Furthermore, remotely located computing devices could be remotely connected to networks via a modem and a temporary communication link. In essence, network 102 may include virtually any communication technology by which information may travel between computing devices. Additionally, in the various embodiments, the communicated information may include virtually any kind of information including, but not limited to processor-readable instructions, data structures, program modules, applications, raw data, control data, archived data, video data, voice data, image data, text data, and the like.

Network 102 may be partially or entirely embodied by one or more wireless networks. A wireless network may include any of a variety of wireless sub-networks that may further overlay stand-alone ad-hoc networks, and the like. Such sub-networks may include mesh networks, Wireless LAN (WLAN) networks, Wireless Router (WR) mesh, cellular networks, pico networks, PANs, Open Air Laser networks, Microwave networks, and the like. Network 102 may further include an autonomous system of intermediate network devices such as terminals, gateways, routers, switches, firewalls, load balancers, and the like, which are coupled to wired and/or wireless communication links. These autonomous devices may be operable to move freely and randomly and organize themselves arbitrarily, such that the topology of network 102 may change rapidly.

Network 102 may further employ a plurality of wired and wireless access technologies, e.g., 2nd (2G), 3rd (3G), 4th (4G), 5^{th} (5G) generation wireless access technologies, and the like, for mobile devices. These wired and wireless access technologies may also include Global System for Mobile communication (GSM), General Packet Radio Services (GPRS), Enhanced Data GSM Environment (EDGE), Code Division Multiple Access (CDMA), Wideband Code Division Multiple Access (WCDMA), Long Term Evolution Advanced (LTE), Universal Mobile Telecommunications System (UMTS), Orthogonal frequency-division multiplexing (OFDM), Wideband Code Division Multiple Access (W-CDMA), Code Division Multiple Access 2000 (CDMA2000), Evolution-Data Optimized (EV-DO), High-Speed Downlink Packet Access (HSDPA), IEEE 802.16 Worldwide Interoperability for Microwave Access (WiMax), ultra wide band (UWB), user datagram protocol (UDP), transmission control protocol/Internet protocol (TCP/IP), any portion of the Open Systems Interconnection (OSI) model protocols, Short Message Service (SMS), Multimedia Messaging Service (MMS), Web Access Protocol (WAP), Session Initiation Protocol/Real-time Transport Protocol (SIP/RTP), or any of a variety of other wireless or wired communication protocols. In one non-limiting example, network 102 may enable a mobile device to wirelessly access a network service through a combination of several radio network access technologies such as GSM, EDGE, SMS, HSDPA, and the like. Thus, the invention is not to be construed as being limited to a single environment, and other configurations, and architectures are also envisaged.

### Illustrative Imaging Device

FIG. 2 shows one embodiment of imaging device 200 that may be included in a system implementing the invention. Imaging device 200 may include many more or less components than those shown in FIG. 2. However, the components shown are sufficient to disclose an illustrative embodiment for practicing the present invention. Imaging device 200 may represent, for example, one or more of projectors 112 and 116 of FIG. 1. Imaging device 200 may represent one or more of printers 114 of FIG. 1. Imaging device 200 may represent one or more of monitors 118 of FIG. 1. Imaging device 200 may represent one or more of smart boards 119 of FIG. 1. In some embodiments, imaging device 200 may be configured to print an image and employ laser print technology. However, the invention is not so constrained, and other print technologies may also be employed without departing from the scope of the invention, including but not limited to LED printers (or other toner-based printing technologies), liquid inkjet printers, solid ink printers, dye-sublimation printers, inkless printers such as thermal printers and UV printers, dot-matrix printers, line printers, pen-based plotters, and the like. In some embodiments, imaging device 200 may represent a multi-function printer (MFP).

In some embodiments, imaging device 200 may be configured to project an image on a remotely located surface and may employ any projecting technology. In some embodiments, imaging device 200 may be configured to display an image. The display may be a liquid crystal display (LCD), gas plasma, light emitting diode (LED), organic LED, or any other type of display used with a computing device. The display may also include a touch sensitive screen arranged to receive input from an object such as a stylus or a digit from a human hand.

As shown, imaging device 200 may include central processing unit 212, one or more network interfaces 210, processor readable storage medium 240, input/output interface 242, display 244, infrared (IR) interface 246, toner assembly 260, printing assembly 262, keyboard and/or keypad 264, pointing device 266, projecting assembly 268, and a mass memory, all in communication with each other via bus 214. The mass memory may generally include RAM 216, and ROM 250, and may also include a processor readable storage medium 240. As illustrated in FIG. 2, imaging device 200 may communicate with the Internet, or some other communications network, via network interface(s) 210, employing various communication protocols including but not limited to TCP/IP, Wi-Fi, Bluetooth, or the like. Communications may also be over a universal serial port (USB); a parallel port; a serial bus such as RS-232 (Recommended Standard 232), ANSI/TIA/EIA-422, or the like; IEEE 1394 (e.g., Firewire); or the like. Network interface unit(s) 210 is sometimes known as a transceiver, transceiving device, or network interface card (NIC).

IR interface 246 may enable communication between imaging device 200 and a client device such as smartphone client device 122 depicted in FIG. 1. IR interface 246 may support communication via an IR communication protocol such as the Infrared Data Association (IrDA) protocol, or the like. In some embodiments, IR interface 246 may support communications with a client device that is with a short range of, and/or in line-of-sight with imaging device 200. Connection 130 depicted in FIG. 1 illustrates an example of such a direct communication between smartphone client device 122 and one or more of imaging devices 122-128.

Keyboard/keypad 264 may comprise any input device arranged to receive input from a user. For example, keyboard/keypad 264 may include a push button numeric dial, keyboard, touch screen, or the like. Keyboard/keypad 264 may include alphabetic inputs, numeric inputs, and/or other character inputs, and may further include function and/or command buttons associated with functionality for selecting, examining, editing, and/or printing documents. User inputs made via keyboard/keypad 264 may be shown in display 244.

Pointing device 266 may include virtually any device that enables a user to input spatial and/or positional data to imaging device 200. Pointing device 266 may include devices based on the user touching a surface, such as a touchpad, touchscreen, graphics tablet, joystick or pointing stick, either with a body part (e.g. finger or hand) or with an object such as a wand, stylus, pen, lightpen and the like. Pointing device 266 may further include devices based on the user moving an object, such as a mouse, trackball, joystick, and the like. User inputs made via pointing device 266 may be shown in display 244.

Display 244 may include virtually any type of display, monitor, terminal, screen and the like that displays text, graphics, images, and/or any other type of data to a user. Types of displays may include, but are not limited to, a liquid crystal display (LCD), gas plasma, light emitting diode (LED), cathode ray tube (CRT), or the like. Display 244 may also interface to keyboard/keypad 264 and/or pointing device 266 to receive and display user input. Additionally, or alternatively, imaging device 200 may communicate with one or more display devices that are external to the printer, to display information regarding print jobs and/or the documents to be examined and modified by a user.

Input/output interface 242 may include various means for communicating with external devices, such as external displays, user input devices, computer devices, networking devices, and the like. Input/output interface 242 may employ one or more communications technologies including but not limited to USB, Bluetooth, serial port (e.g. RS-232 standard), parallel port (e.g. IEEE 1284 standard), and the like.

The mass memory as described above illustrates an exemplary type of computer-readable media, namely computer-readable or processor-readable storage media. Such mass memory included in imaging device 200 may include RAM 216 and ROM 250, and/or processor readable storage medium 240. Computer-readable storage media, or processor-readable storage media, may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory such as RAM 216 may store operating system 220 for controlling the operation of imaging device 200. Any general-purpose operating system (e.g. Windows, UNIX, LINUX, and the like) that supports the functionality of imaging device 200 may be employed. In some embodiments, operating system 220 may be a specially configured version of a general-purpose operating system, or may be a specialized operating system designed and created to support the functionality of imaging device 200. Operating system 220 may include or interface with a virtual machine module such as the Java virtual machine or Microsoft .NET runtime that may enable control of hardware components and/or operating system functions via applications that run under such virtual machine modules. Basic input/output system (“BIOS”) 252 may also be provided for controlling the low-level operation of imaging device 200, such as startup, diagnostics, and the like. As shown in FIG. 2, BIOS may be stored in and/or executed from mass memory such as ROM 250.

The mass memory may also store program code, instructions, and/or data. For example data storage 222 may be configured to store imaging commands, diagnostics, user preferences, imaging control software, information regarding the capabilities of the imaging device such as supported color palettes, fonts, pagination, page size, and the like. Data storage 222 may further store documents to be imaged, intermediate documents, information regarding user edits and/or modifications, raster images of documents to be imaged, and the like, as well as any other information needed for selecting, examining, editing, modifying, displaying, projecting and/or printing the documents.

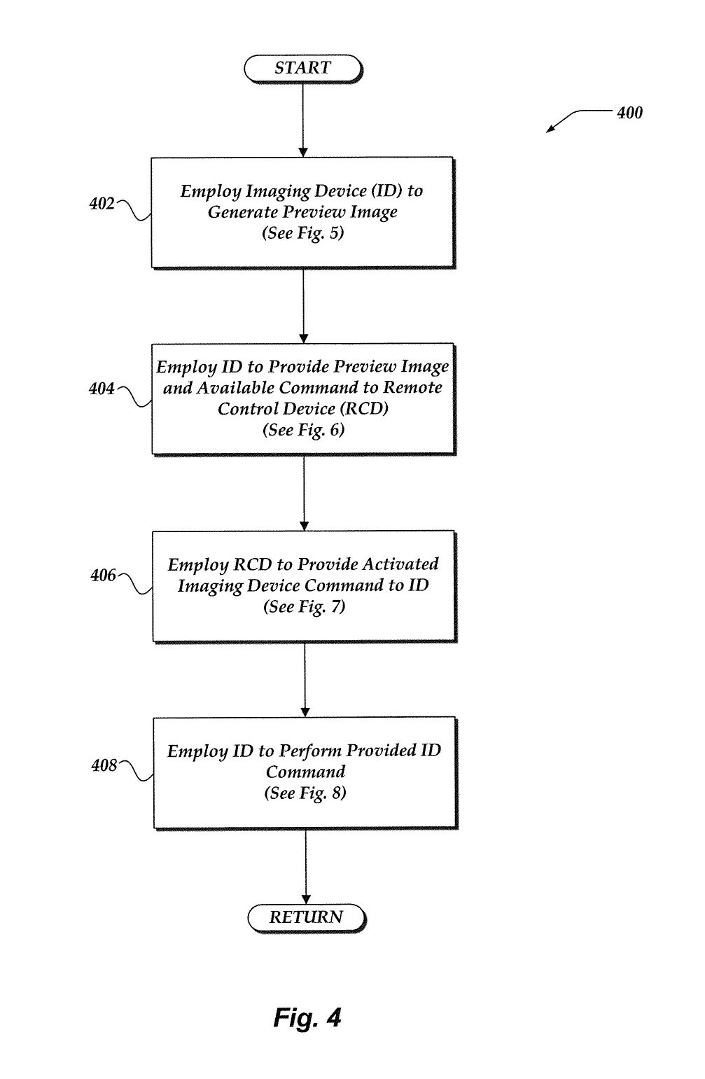

In some embodiments, mass memory may also store one or more applications 224, programs, software modules and the like for the operation of embodiments of the invention. Such applications 224 may include remote control server application 226 and document server 228. The general operation of these applications is described further herein with regard to FIGS. 4-9. In some embodiments, one or both of remote control server application 226 and document server 228 may store, cache, and/or access data in data storage 222 and/or processor readable storage medium 240, and may display information at display 244. Mass memory such as RAM 216 may also include other applications 230 that may also be configured to store, cache and/or access data in data storage 226 and/or processor readable storage medium 240, and may display information at display 244. Applications 226, 228, and 230 may be loaded into mass memory and run on operating system 220. Although such applications are illustrated as included in RAM 216, the invention is not so limited. For example, one or more of applications 226, 228 and/or 230 may also be loaded into and/or run on ROM 250 and/or processor readable storage medium 240 without departing from the scope of the invention.

As stated herein, imaging device 200 may incorporate various types of printing technologies without departing from the scope of the invention. In some embodiments, imaging device 200 may be configured to employ laser printing technology. The following is an exemplary, non-limiting description of laser printing technology that may be employed to implement embodiments of the invention. In such embodiments, printing assembly 262 may include such elements as are necessary for laser printing, such as a drum assembly, corona wire, fuser, discharge lamp, laser scanning unit, and/or photoreceptor. In some embodiments, drum assembly may be configured to revolve, and may be made of any of a variety of photoconductive materials. The drum assembly may be given an electric charge by the corona wire (or in some embodiments by a charged roller). As the drum assembly rotates, a laser scanning unit may direct a laser beam across the drum assembly's surface based on the data to be printed. A toner assembly 260 may provide toner, such as in a powder form, onto the drum assembly. A corona wire may further provide a charge to paper or other print material, which may then be moved over the drum assembly. The paper or other print material may then pass through a fuser such that the applied toner is heated or otherwise caused to adhere to the paper or other print material. Upon depositing toner to the paper or other print material, the surface of the drum of the drum assembly may pass a discharge lamp where a light, or the like, may expose the drum to erase or remove the electrical image. In one embodiment, the drum surface of the drum assembly may then pass the corona wire, which may then reapply a charge. It should be noted that embodiments of the invention are not limited to this method of transferring data onto a print material, and other mechanisms may also be used. Thus, the invention is not to be constrained or otherwise narrowed by this embodiment.

As stated herein, imaging device 200 may incorporate various types of projecting technologies without departing from the scope of the invention. In some embodiments, imaging device 200 may be configured to employ video projecting technology, LCD projector technology, film projector technology, handheld projector technology, laser video projector technology, digital projector technology, and any other projector technology. In such embodiments, projector assembly 268 may include such elements as are necessary for projector, such as one or more light sources, one or more optical elements including lens, mirrors, apertures, prisms, optical filters, and the like, lasers, one or more image sources, including video images, and other elements. It should be noted that embodiments of the invention are not limited to these projecting technologies. As used herein, projecting refers to any method or technology that enables the display of an image, video signal, or an data or document on a surface. Thus, the invention is not to be constrained or otherwise narrowed by these embodiments.

### Illustrative Client Device

FIG. 3 shows one embodiment of client device 300 that may include many more or less components than those shown. Client device 300 may represent, for example, at least one embodiment of client devices shown in FIG. 1.

Client device 300 may include processor 302 in communication with memory 304 via bus 328. Client device 300 may also include power supply 330, network interface 332, audio interface 356, display 350, keypad 352, illuminator 354, video interface 342, input/output interface 338, haptic interface 364, global positioning systems (GPS) receiver 358, open air gesture interface 360, temperature interface 362, camera(s) 340, projector 346, pointing device interface 366, processor-readable stationary storage device 334, and processor-readable removable storage device 336. Client device 300 may optionally communicate with a base station (not shown), or directly with another computing device. And in one embodiment, although not shown, a gyroscope may be employed within client device 300 to measuring and/or maintaining an orientation of client device 300.

Power supply 330 may provide power to client device 300. A rechargeable or non-rechargeable battery may be used to provide power. The power may also be provided by an external power source, such as an AC adapter or a powered docking cradle that supplements and/or recharges the battery.

Network interface 332 includes circuitry for coupling client device 300 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 332 is sometimes known as a transceiver, transceiving device, or network interface card (NIC).

Audio interface 356 may be arranged to produce and receive audio signals such as the sound of a human voice. For example, audio interface 356 may be coupled to a speaker and microphone (not shown) to enable telecommunication with others and/or generate an audio acknowledgement for some action. A microphone in audio interface 356 can also be used for input to or control of client device 300, e.g., using voice recognition, detecting touch based on sound, and the like.

Display 350 may be a liquid crystal display (LCD), gas plasma, electronic ink, light emitting diode (LED), Organic LED (OLED) or any other type of light reflective or light transmissive display that can be used with a computing device. Display 350 may also include a touch interface 344 arranged to receive input from an object such as a stylus or a digit from a human hand, and may use resistive, capacitive, surface acoustic wave (SAW), infrared, radar, or other technologies to sense touch and/or gestures.

Projector 346 may be a remote handheld projector or an integrated projector that is capable of projecting an image on a remote wall or any other reflective object such as a remote screen.

Video interface 342 may be arranged to capture video images, such as a still photo, a video segment, an infrared video, or the like. For example, video interface 342 may be coupled to a digital video camera, a web-camera, or the like. Video interface 342 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 352 may comprise any input device arranged to receive input from a user. For example, keypad 352 may include a push button numeric dial, or a keyboard. Keypad 352 may also include command buttons that are associated with selecting and sending images.

Illuminator 354 may provide a status indication and/or provide light. Illuminator 354 may remain active for specific periods of time or in response to events. For example, when illuminator 354 is active, it may backlight the buttons on keypad 352 and stay on while the client device is powered. Also, illuminator 354 may backlight these buttons in various patterns when particular actions are performed, such as dialing another client device. Illuminator 354 may also cause light sources positioned within a transparent or translucent case of the client device to illuminate in response to actions.

Client device 300 may also comprise input/output interface 338 for communicating with external peripheral devices or other computing devices such as other client devices and network devices. The peripheral devices may include an audio headset, display screen glasses, remote speaker system, remote speaker and microphone system, and the like. Input/output interface 338 can utilize one or more technologies, such as Universal Serial Bus (USB), Infrared, WiFi, WiMax, Bluetooth™, and the like.

Haptic interface 364 may be arranged to provide tactile feedback to a user of the client device. For example, the haptic interface 364 may be employed to vibrate client device 300 in a particular way when another user of a computing device is calling. Temperature interface 362 may be used to provide a temperature measurement input and/or a temperature changing output to a user of client device 300. Open air gesture interface 360 may sense physical gestures of a user of client device 300, for example, by using single or stereo video cameras, radar, a gyroscopic sensor inside a device held or worn by the user, or the like. Camera 340 may be used to track physical eye movements of a user of client device 300.

GPS transceiver 358 can determine the physical coordinates of client device 300 on the surface of the Earth, which typically outputs a location as latitude and longitude values. GPS transceiver 358 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client device 300 on the surface of the Earth. It is understood that under different conditions, GPS transceiver 358 can determine a physical location for client device 300. In at least one embodiment, however, client device 300 may, through other components, provide other information that may be employed to determine a physical location of the device, including for example, a Media Access Control (MAC) address, IP address, and the like.

Human interface components can be peripheral devices that are physically separate from client device 300, allowing for remote input and/or output to client device 300. For example, information routed as described here through human interface components such as display 350 or keyboard 352 can instead be routed through network interface 332 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a client device with such peripheral human interface components is a wearable computing device, which might include a remote pico projector along with one or more cameras that remotely communicate with a separately located client device to sense a user's gestures toward portions of an image projected by the pico projector onto a reflected surface such as a wall or the user's hand.

A client device may include a browser application that is configured to receive and to send web pages, web-based messages, graphics, text, multimedia, and the like. The client device's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 304 may include RAM, ROM, and/or other types of memory. Memory 304 illustrates an example of computer-readable storage media (devices) for storage of information such as computer-readable instructions, data structures, program modules or other data. Memory 304 may store BIOS 308 for controlling low-level operation of client device 300. The memory may also store operating system 306 for controlling the operation of client device 300. It will be appreciated that this component may include a general-purpose operating system such as a version of UNIX, or LINUX™, or a specialized mobile computer communication operating system such as Windows Phone™, or the Symbian® operating system. The operating system may include, or interface with a Java virtual machine module that enables control of hardware components and/or operating system operations via Java application programs.

Memory 304 may further include one or more data storage 310, which can be utilized by client device 300 to store, among other things, applications 320 and/or other data. For example, data storage 310 may also be employed to store information that describes various capabilities of client device 300. The information may then be provided to another device based on any of a variety of events, including being sent as part of a header during a communication, sent upon request, or the like. Data storage 310 may also be employed to store social networking information including address books, buddy lists, aliases, user profile information, or the like. Data storage 310 may further include program code, data, algorithms, and the like, for use by a processor, such as processor 302 to execute and perform actions. In one embodiment, at least some of data storage 310 might also be stored on another component of client device 300, including, but not limited to, non-transitory processor-readable removable storage device 336, processor-readable stationary storage device 334, or even external to the client device.

Applications 320 may include computer executable instructions which, when executed by client device 300, transmit, receive, and/or otherwise process instructions and data. Applications 320 may include, for example, remote control client 322. Other examples of application programs include document client 324, browsers 326, calendars, search programs, email client applications, IM applications, SMS applications, Voice Over Internet Protocol (VoIP) applications, contact managers, task managers, transcoders, database programs, word processing programs, security applications, spreadsheet programs, games, search programs, and so forth.

Remote control client 322 may be configured to enable a user of the client device to remotely access the capabilities of an imaging device. In at least one embodiment, remote control client 322 may receive a preview image based on a document provided to the imaging device. In at least one embodiment, remote control client 322 may determine available commands associated with a preview image for remotely controlling the operation of the imaging device with an image of the document. In some embodiments, remote control client 322 may display a user interface and a preview image to a user. In some embodiments, remote control client 322 may enable a user to select available commands associated with a preview image for accessing the capabilities of the imaging device. In at least one embodiment, remote control client 322 may update a preview image. In some embodiments, remote control client 322 may provide selected imaging device commands to an imaging device. In any event, remote control client 322 may employ processes, or parts of processes, similar to those described in conjunction with FIGS. 4-9, to perform at least some of its actions. In at least one embodiment, each available imaging device command may correspond to at least one capability of the imaging device. Also, in at least one embodiment, each available imaging device command may further correspond to at least one attribute of the document.

### General Operation

The operation of certain aspects of the invention will now be described with respect to FIGS. 4-9. FIG. 4 illustrates a logical flow diagram generally showing one embodiment of an overview process for remotely controlling imaging devices using preview images. In some embodiments, process 400 or portions of process 400 of FIG. 4 may be implemented by and/or executed by at least one or more imaging devices, such as imaging device 200 of FIG. 2. In some embodiments, process 400 or portions of process 400 of FIG. 4 may be implemented by and/or executed by at least one or more client devices, such as client device 300 of FIG. 3. However, embodiments are not so limited and various combinations of imaging devices and client devices, or the like may be utilized.

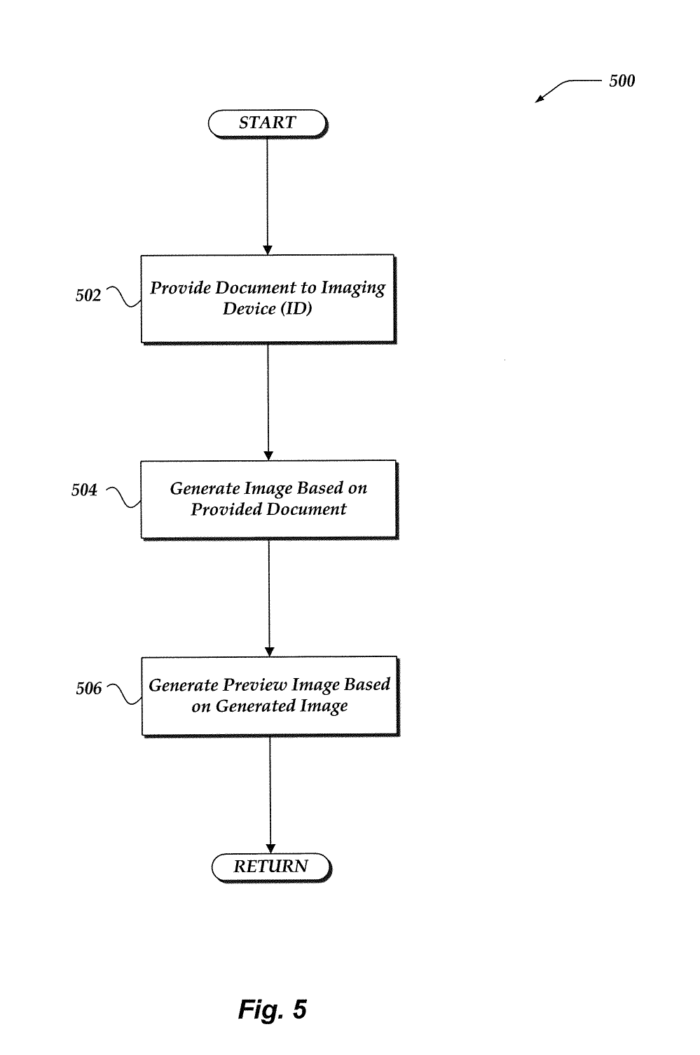

Process 400 begins, after a start block, at block 402, where an imaging device is employed to generate at least on preview image. In at least one embodiment, the generated image may be of a document. In at least one embodiment, the preview image may be of a document provided to the imaging device. Block 402 is described in more detail with regard to FIG. 5. However, briefly stated, at block 402, the preview image of an image may be generated at the imaging device, where the imaging device may be enabled to print, fax, project, display, or otherwise present the image. In at least one embodiment, the imaging device may generate the preview image. In some embodiments, the generated preview image may be a preview image of an image of a document.

In some embodiments, more than one preview image may be generated at block 402. In some embodiments, at least one preview image may be generated for each of a plurality of images to be printed, faxed, projected, displayed, or otherwise presented by the imaging device. Each of the plurality of images may correspond to at least one page of the document. In at least one of the various embodiments, each of the generated preview images may correspond to at least one page of the document.

In at least one of the various embodiments, the image to be printed, faxed, projected, displayed, or otherwise presented by the imaging device may be a bitmap image. In some embodiments, the generated preview image may be a bitmap image. Each bitmap image may be at least partially characterized by an image resolution and a number of bits per pixel value. A resolution may be characterized by at least one of a number of pixel rows, a number of pixel columns, a pixel density value, a total number of pixels, or any other similar indication.

The resolution associated with the preview image may be less than, greater than, or equal to the resolution associated with the image to be printed, faxed, projected, displayed, or otherwise presented by the imaging device. In at least one of the various embodiments, the preview image may be a color image, a gray scale image, or the like. The number of bits per pixel value associated with the preview image may be less than, greater than, or equal to the number of bits per pixel value associated with the image to be printed, faxed, projected, displayed, or presented by the imaging device. In some embodiments, the preview image may be a thumbnail of the image to be printed, faxed, projected, displayed, or otherwise presented by the imaging device. In some embodiments, the preview image may be a vector graphics image, a bitmapped image, or the like. In at least one embodiment, the image to be printed, faxed, projected, displayed, or otherwise presented may be a vector graphics image, a bitmapped image, or the like.

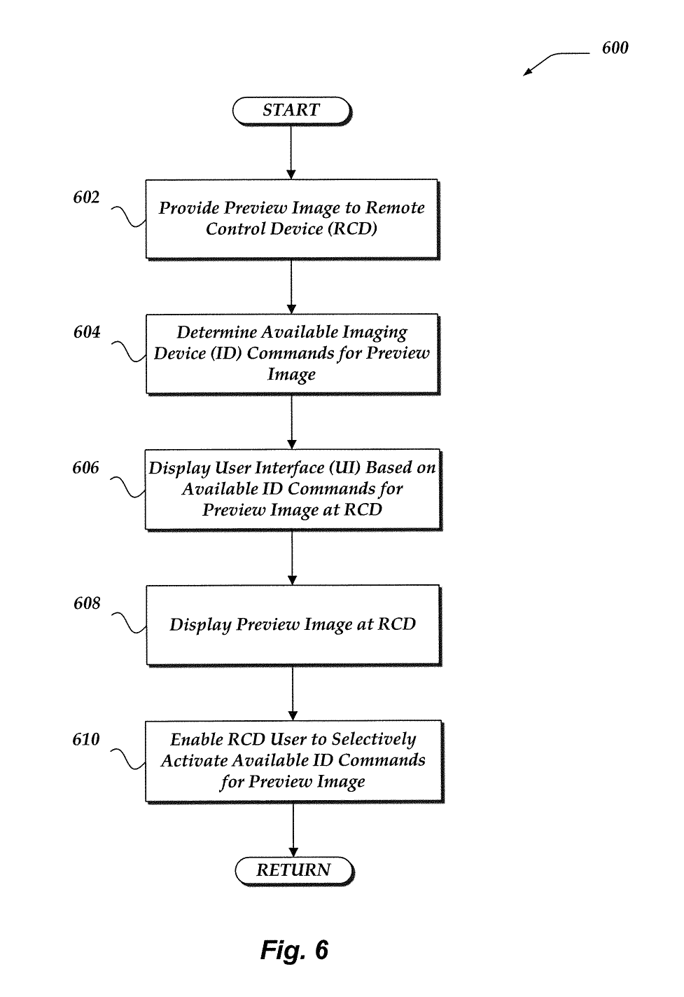

Process 400 proceeds to block 404, where the imaging device is employed to provide a preview image to a client device. Block 404 is described in more detail with regard to FIG. 6. However, briefly stated, at block 404, the imaging device is employed to provide at least one preview image to a client device and at least one available command to the client device. In at least one embodiment, the at least one available command may be based on an attribute of the document. In at least one embodiment, the at least one available command may be based on a capability of the imaging device.

In some embodiments, the preview image provided to a client device may be the preview image generated at block 402. In some embodiments, the client device may be client device 300 of FIG. 3. In some embodiments, the client device may be a remote device. The client device may be a remote control device. In at least one of the various embodiments, more than one preview image may be provided to the remote device. In at least one embodiment, more than one available command may be provided to the remote device.

In at least one of the various embodiments, the imaging device that generated the preview image in block 402 may provide the preview image to the remote device. In some embodiments, another imaging device may provide the preview image to the remote device. In at least one of the various embodiments, another resource, such as another device may provide the preview image to the remote device. The preview image may be provided to the remote device through the use of a wired or wireless network, such as network 102 of FIG. 1. In some embodiments, the preview image may be provided to the remote device through the use of other resources.

In at least one embodiment, the remote device may be employed to display the at least one preview image and the at least one available command. In at least one embodiment, an activation of the at least one available command may enable an operation of the imaging device. In at least one of the various embodiments, the enabled operation of the imaging device may be to at least provide a representation of the image. In at least one embodiment, the enabled operation of the imaging device may be to at least update a representation of the image.

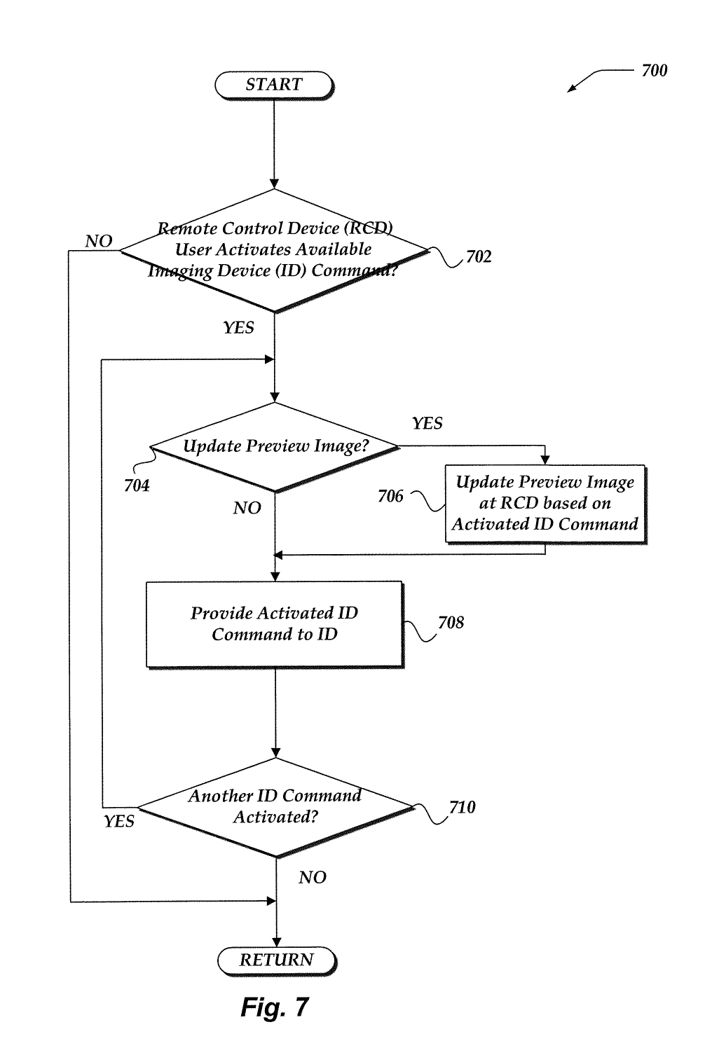

In any event, process 400 proceeds to block 406, a command, activated at the remote device, may be provided to an imaging device. In at least one embodiment, the activated command may be an imaging device command. Block 406 is described in more detail with regard to FIG. 7. However, briefly stated, at block 406, an imaging device command, activated at a remote device, may be provided to at least one imaging device. In some embodiments, a user of the remote device selects or activates an available imaging device command that was provided to the remote device in block 404. The user may be a user of the remote device that was provided the preview image in block 404. In at least one of the various embodiments, the activated imaging device command may be provided to at least the imaging device where the preview image was generated in block 402. In some embodiments, the activated imaging device command may be provided to at least one other imaging device.

In some embodiments, the remote device may provide the imaging device command to the imaging device. In at least one embodiment, another resource may provide the imaging device command to the imaging device. In some embodiments, the imaging device command may be activated automatically. In some embodiments, the user may activate the imaging device command in response to one or more of the preview images provided to the remote control device. In at least one of the various embodiments, more than one imaging device command may be activated at the remote control device and provided to the imaging device.

If more than one imaging device command is activated at the remote control device, the order that the imaging device commands are activated in may be conserved, so that the imaging device commands are provided to the imaging device in the same order as the imaging device commands were activated. Each of the provided imaging device commands may be associated with one or more of the preview images. Each of the provided imaging device commands may be associated with one or more images at the imaging device. In some embodiments, each of the available imaging device commands may correspond to at least one capability of the imaging device. Non-limiting examples of such imaging device capabilities and corresponding imaging device commands are detailed with regard to block 408. In at least one embodiment, an activated command may be based on an attribute of a document that the preview image is based on.

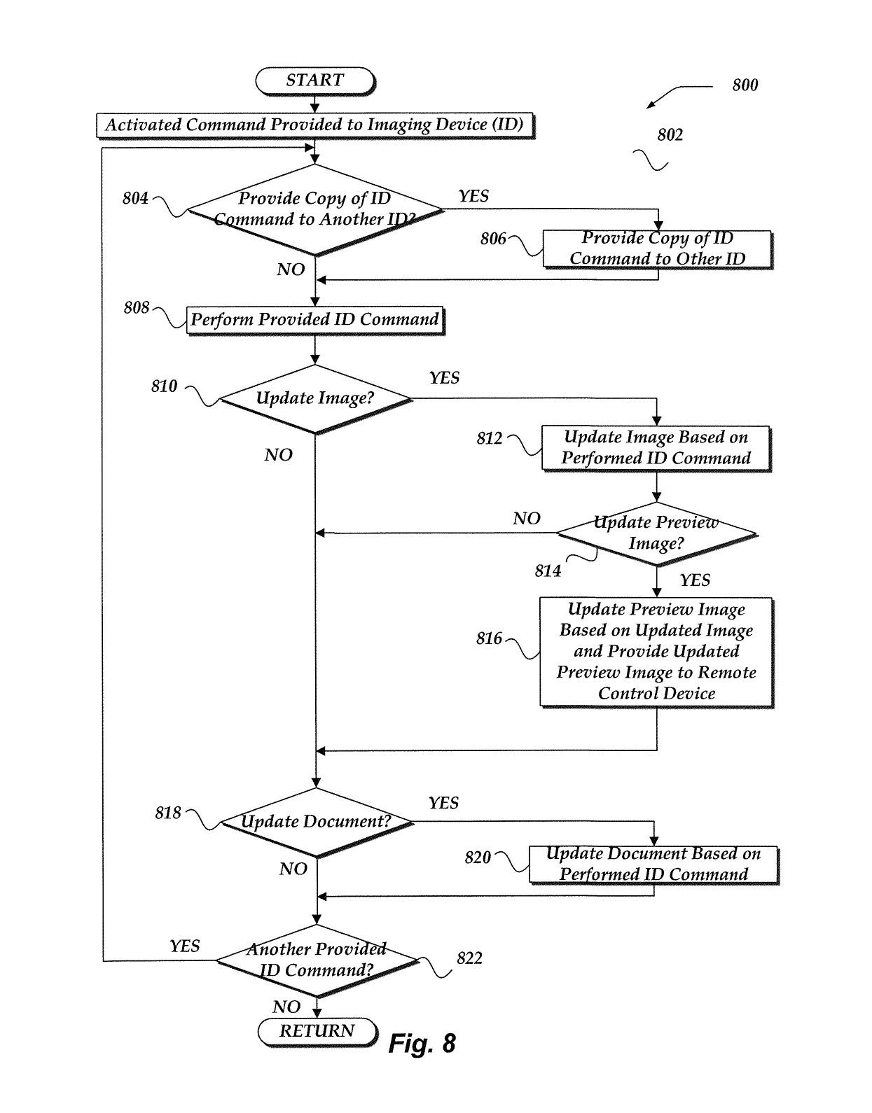

Process 400 proceeds to block 408, where an imaging device may be employed to perform an imaging device command. Block 408 is described in more detail with regard to FIG. 8. However, briefly stated, at block 408, an imaging device may be employed to perform the imaging device command that was provided in block 406. In some embodiments, the imaging device that was provided the imaging device command in block 408 performs the imaging device command. In at least one embodiment, another imaging device performs the imaging device command. In at least one embodiment, performing the command may present at least one representation of the image. In at least one embodiment, the representation of the image may be based on selective activation of an available command at the remote device.

Performing the provided imaging device command may access at least one capability of the imaging device, and the activated command may correspond to the at least one imaging device capability. In at least one embodiment, the at least one imaging device capability may include presenting at least one representation of an image of an document provided to the imaging device. For instance, in some embodiments, performing the provided imaging device command may print, fax, project, display, or otherwise present at least one image at the imaging device. In some embodiments, performing the provided imaging device command may update, re-arrange the order of, or otherwise modify one or more images to be printed, faxed, projected, displayed, or presented by the imaging device. In some embodiments, performing the provided imaging device command may update or modify an image in real time, including before, during, or after the image, or the updated image, is printed, faxed, projected, displayed, or otherwise presented by the imaging device.

Non-limiting examples of imaging device capabilities and corresponding imaging device commands for some embodiments may include updating an image with a letterhead, watermark, header/footer, or page number before the image, or updated image, is printed, faxed, projected, displayed, or otherwise presented by the imaging device. In some embodiments, the imaging device may provide the capability to update the image by cropping and/or zooming in or out of the image before the image, or updated image, is printed, faxed, projected, displayed, or presented. The imaging device may provide the capability of updating the image by color correcting or sharpening the image before the image, or the updated image, is printed, faxed, projected, displayed, or presented.

If multiple images are to be printed, faxed, projected, displayed, or presented, the imaging device may provide the capability of defining an order of or updating a predefined order in which to print, fax, project, display, or present the multiple images. In some embodiments, the imaging device may provide the capability to update an image by highlighting portions of an image, or add visual cues such as bullet points, arrows, or other such demarcations, before the image, or the updated image, is printed, faxed, projected, displayed, or generated. In some embodiments, the imaging device may provide the capability to update an image by adding text or updating pre-existing text included in an image, including updating font, color, or font size attributes of the text, updating the visual presentation or font effects of the text, such as adding underlines, italics, or making text bold before the image, or updated image, is printed, faxed, projected, displayed, or presented.

In some embodiments, the imaging device may provide the capability to project a laser onto a projected image, and vary the location of the projected laser on the image in real time, in order to produce a laser pointer effect. In some embodiments, the imaging device may provide the capability to update a projected image with highlighted pixels or such, so that the highlighted pixels emulate a laser pointer, and vary the position of the highlighted pixels in real time. In at least one of the various embodiments, the imaging device may provide the capability to update the image with animation or video effects. In some embodiments, the imaging device may provide the capability to update any visual aspect of the image before the image is printed, faxed, projected, displayed, or presented. This enumeration of imaging device capabilities is exemplary and non-exhaustive and is not limiting for any embodiments. In some embodiments, an imaging device command corresponds to at least one of the imaging device capabilities. In at least one embodiment, each imaging device capability may be accessed by the imaging device performing a corresponding imaging device command. In some embodiments, each command that may access an imaging device capability may be selectable at a remote control device.

In some embodiments, more than one command may be pertained. If the imaging device performs more than one command, the order that the commands are performed may be significant for the image, or updated image, that is printed, faxed, projected, displayed, or generated. In some embodiments, multiple imaging device commands are performed in the same order for which the multiple imaging device commands were provided to the imaging device. In some embodiments, the order that multiple imaging device commands are performed may be insignificant and the imaging device commands are performed in an order that varies from the order that the imaging device commands where provided to the imaging device.

After block 408, process 400 may return to a calling process to perform other actions.

FIG. 5 illustrates a logical flow diagram generally showing one embodiment of a process for employing an imaging device to generate a preview image. In some embodiments, process 500 or portions of process 500 of FIG. 5 may be implemented by and/or executed by at least one or more imaging devices, such as imaging device 200 of FIG. 2. In some embodiments, process 500 or portions of process 500 of FIG. 5 may be implemented by and/or executed by at least one or more client devices, such as client device 300 of FIG. 3. However, embodiments are not so limited and various combinations of imaging devices and client devices, or the like may be utilized.

Process 500 begins, after a start block, at block 502, where a document may be provided to an imaging device. The document may be provided to an imaging device enabled to print, fax, project, display, or otherwise present an image of the document. In some embodiments, the provided document may be in a format such that the imaging device is enabled to directly print, fax, project, display, or otherwise present the document. In at least one of the various embodiments, more than one document may be provided to the imaging device. Each document provided may include one or more pages, slides, images, or such to be printed, faxed, projected, displayed, or otherwise presented. The provided document may contain any combination of text, graphics, images, photographs, multimedia data, or other data that may be printed, faxed, projected, displayed, or presented. In at least one embodiment, the provided document may include a video signal. The document may be cached, or otherwise stored at the imaging device.

In some embodiments, the document may be provided to a document server application, such as document server 228 of FIG. 2. In at least one of the various embodiments, a client device may provide the document to the imaging device. The client device may be a remote control device. In some embodiments, a document client application, such as document client 324 of FIG. 3 may provide the document to the imaging device. In some embodiments, the document may be provided to the imaging device by other resources. In at least one of the various embodiments, the document may be provided to an imaging queue. The imaging queue may be a print queue. The imaging queue may be a secure queue. In some embodiments, the imaging queue may be a hold and print queue. In some embodiments, the document may already be stored at the imaging device and the document is not provided to the imaging device in process 500. In at least one of the various embodiments, the document may be generated at the imaging device.

Process 500 proceeds to block 504, where an image of the document provided in block 502, is generated at the imaging device. In some embodiments, the imaging device may not be enabled to directly print, fax, project, display, or otherwise present the document provided to the imaging device. Thus, an image of the document may be generated, and the imaging device may be enabled to print, fax, project, display, or otherwise present the generated image. In some embodiments, more than one image may be generated by the imaging device at block 504. At least one image may be generated for each page of the document. Each generated image may correspond to at least one page of the document. The image may be cached, or otherwise stored at the imaging device.

In at least one of the various embodiments, the generated image may be a bitmapped image. The generated image may have an associated resolution and number of bits per pixel. The image may be a color image or a gray scale image. In some embodiments, the image may be a vector graphics image. In some embodiments, the document provided to the imaging device may be in format for which the imaging device is enabled to directly print, fax, project, display, or present the document. For these embodiments, it may not be necessary for the imaging device to generate an image of the document.

In any event, process 500 proceeds to block 506, where a preview image is generated at the imaging device. The preview image may be a preview of the image generated at block 504. In some embodiments, the preview image is at least based on the image generated at block 504. In some embodiments, more than one preview image may be generated at block 506. In some embodiments, at least one preview image is generated for each of the images generated at block 504. The preview image may be cached, or otherwise stored at the imaging device.

In some embodiments, the preview image may be based on the document provided to the imaging device at block 502. The preview image may be a preview image of the document. In at least one of the various embodiments, each generated preview image may correspond to at least one page of the document.

After block 506, process 500 may return to a calling process to perform other actions.

FIG. 6 illustrates a logical flow diagram generally showing one embodiment of a process for employing an imaging device to provide a preview image and available command to a remote control device. In some embodiments, process 600 or portions of process 600 of FIG. 6 may be implemented by and/or executed by at least one or more imaging devices, such as imaging device 200 of FIG. 2. In some embodiments, process 600 or portions of process 600 of FIG. 6 may be implemented by and/or executed by at least one or more client devices, such as client device 300 of FIG. 3. However, embodiments are not so limited and various combinations of imaging devices and client devices, or the like may be utilized.

Process 600 begins, after a start block, at block 602, where a preview image is provided to a client device, such as client device 300 of FIG. 3. In some embodiments, the client device may be a remote device. In at least one of the various embodiments, the client device may be a remote control device. In some embodiments, the preview image is provided by an imaging device, such as imaging device 200 of FIG. 2. The provided preview image may be generated by a process, or a portion of the process such as that depicted in block 402 of FIG. 4 or process, or portion of process 500 of FIG. 5. The preview image may be cached, or otherwise stored at the remote device.

In some embodiments, an imaging device may be employed to provide the preview image to the remote control device. In at least one of the various embodiments, the imaging device that generated the preview image in block 402 of FIG. 4 or block 506 of FIG. 5 may provide the preview image to the remote control device. In some embodiments, another imaging device may provide the preview image to the remote control device. In at least one of the various embodiments, another device may provide the preview image to the remote control device. In at least one embodiment, the remote control device that is provided the preview image is the device that provided the document to the imaging device in block 502 of FIG. 5.

At any rate, process 600 proceeds to block 604, where at least one available command is determined. In at least one embodiment, the at least one available command is an imaging device command. In at least one embodiment, the at least one command is based on at least one attribute of a document associated with the preview image provided at block 602. In at least one embodiment, a list of available imaging device commands may be determined. In some embodiments, the determined available imaging device commands are available for the document associated with the preview image, or the image of the document. Each of the available imaging device commands may correspond to at least one of the capabilities of the imaging device.

In at least embodiment, determining available imaging device commands may be based on the preview image provided in block 602. In at least one embodiment, determining available imaging device commands may be based on the total number of preview images provided to the remote control device. In at least one of the various embodiments, determining available imaging device commands may be based on the capabilities of an imaging device, where the capabilities are available for an image that corresponds to the provided preview image.

The available imaging device commands may be determined at the imaging device that provided the preview image in block 602. In such embodiments, the determined available imaging device commands may be provided to the remote control device. In at least one embodiment, the available imaging device commands may be determined at the remote control device. In some embodiments, the available imaging device commands may be determined at another device and provided to the imaging device.

At any rate, process 600 proceeds to block 606, where a user interface (UI) may be displayed at the remote control device. In some embodiments, the displayed UI may be based at least in part on the available imaging device commands determined at block 604. In some embodiments, the UI may be based at least in part on the preview image provided to the remote control device at block 602. In at least one embodiment, the UI may be based at least in part on a total number of preview images provided to the remote control device.

In some embodiments, the UI may be a graphical user interface (GUI). In some embodiments, the GUI may display the available imaging device commands determined at block 604. In at least one embodiment, the GUI may be based on an attribute of a document corresponding with the preview image. The available imaging device commands may be displayed in drop down menus, pop-up windows, or in any other style suitable for presenting a user of a remote control device with imaging device commands.

Process 600 continues at block 608, where a preview image is displayed at the remote control device. In some embodiments, the preview image displayed is the preview image provided to the remote control device in block 602. In some embodiments, the preview image is displayed within the UI or GUI displayed at block 606. In some embodiments, more than one preview image may be displayed. Each of the preview images provided at block 602 may be displayed. Multiple preview images may be displayed simultaneously. In some embodiments, a each preview image may be viewed individually and the user is enable with the ability to scroll through the preview images. The preview images may be displayed as a slideshow. In some embodiments, the preview images may be displayed in a two-dimensional array, where each array element includes a single preview image. The preview images may be displayed in any style suitable for displaying images at a remote control device.

At block 610, a user of the remote control device may be enabled to selectively activate an available imaging device command. In some embodiments, the user is enabled to activate an available imaging device command through interacting with the GUI displayed at block 606. In at least one of the various embodiments, the user may be enabled to select or activate an available imaging device command while simultaneously viewing one or more of the preview imaged displayed at block 608.

In some embodiments, the user may be enabled to selectively activate more than one available imaging device command. In some embodiments, the user may be enabled to associate the activated imaging device command with one or more of the displayed preview images. In some embodiments, an activated imaging device command may be associated with at least one image at an imaging device. The user may be enabled to update or modify an activated imaging device command. In some embodiments, the user may be enabled to further select options, settings, ranges, or the like for each of the activated imaging commands. The user may activate imaging device commands, options, settings, ranges, and the like in any manner provided to a user of a remote control device.

After block 610, process 600 may return to a calling process to perform other actions.

FIG. 7 illustrates a logical flow diagram generally showing one embodiment of a process for employing a remote control device to provide an activated imaging device command to an imaging device. In some embodiments, process 700 or portions of process 700 of FIG. 7 may be implemented by and/or executed by at least one or more imaging devices, such as imaging device 200 of FIG. 2. In some embodiments, process 700 or portions of process 700 of FIG. 7 may be implemented by and/or executed by at least one or more client devices, such as client device 300 of FIG. 3. However, embodiments are not so limited and various combinations of imaging devices and client devices, or the like may be utilized.

Process 700 begins, after a start block, at decision block 702, where a determination may be made whether a user of a client device has selectively activated an available command, such as an imaging device command. The client device may be client device 300 of FIG. 3. The client device may be a remote device. In some embodiments, the client device may be a remote control device. The user may have selected an available imaging device command upon being enabled to activate an available imaging device command, such as in block 610 of FIG. 6. If the user has activated an available imaging device command, then process 700 may flow to decision block 704; otherwise process 700 may return to a calling process to perform other actions.

At decision block 704, a determination may be made whether to update a preview image at the remote device. In some embodiments, this determination may be based on the available imaging device command that was determined to have been activated in block 702. In some embodiments, this determination may be based at least in part on a capability of the imaging device that corresponds to the activated imaging device command.

In some embodiments, this determination may be based at least in part on the preview image that may be updated. The preview image that may be updated may be a preview image associated with the activated available imaging device command. This determination may be based at least in part on an image corresponding to the preview image that may be updated. In some embodiments, this determination may be made at the remote control device. In some embodiments, this determination may be made at an imaging device. This determination may be based at least in part on settings configured at the imaging device. In at least one embodiment, this determination may be based on at least one of user credentials, user profile information, software settings, remote control device capabilities, or current remote control device resource utilization. If the preview image is to be updated, then process 700 may proceed to block 706; otherwise process 700 may flow to block 708.

At block 706, the preview image may be updated. The preview image may be updated at the remote control device. In some embodiments, the preview image may be updated at another device. In some embodiments, the updated preview image may be provided to another device. In at least one embodiment, the preview image may be updated at the imaging device that generated the preview image. Updating the preview image may be based at least in part on the activated imaging device command. In some embodiments, updating the preview image may be based at least in part on a capability of the imaging device that corresponds to the activated imaging device command. In at least one embodiment, updating the preview image may be based on an attribute of the document corresponding to the preview image. Updating the preview image may be based, at least in part, on an image at an imaging device that corresponds to the preview image. In at least one embodiment, updating the preview image may be based on at least one of user credentials, user profile information, software settings, remote control device capabilities, or current remote control device resource utilization. The preview image that is updated may be a preview image associated with the activated imaging device command. The updated preview image may be cached, or otherwise stored at the remote control device. In some embodiments, the updated preview image may be cached, or otherwise stored at the imaging device.

For instance, if an imaging device command is activated that corresponds to highlighting a portion of the image to be printed, faxed, projected, displayed, or presented by the imaging device, then the preview image may be updated to include a highlight of a portion of the preview image that corresponds to a portion of the image to be highlighted. Also, if an imaging device command is activated that corresponds to re-arranging the order of images to be printed, faxed, projected, displayed, or otherwise presented by the imaging device, then the order of the preview images may be re-arranged in a corresponding order at the remote control device. In some embodiments, updating the preview image may include emulating a capability of the imaging device that corresponds to the activated imaging device command, as applied to the preview image.

In at least one of the various embodiments, updating the preview image may include updating the preview image to indicate that a corresponding image at the image device may be updated by the capability that corresponds to the activated imaging command. Such updates may include the addition of a visual demarcation to indicate an updated image at the imaging device. For instance, if an imaging device command is activated that corresponds to color correcting an image to be printed, faxed, projected, displayed, or otherwise presented at the imaging device, then the preview image at the remote control device may be updated to include a checkbox, arrow, or other such visual representation to indicate that the corresponding image at the imaging device may be color corrected if the activated command is performed at the imaging device. In some embodiments, the preview image may be updated by color correcting the preview image as indicated by the activated imaging device command.

In some embodiments, more than one preview image may be updated. For instance, if the activated imaging device command corresponds to adding header information to each image before the image is printed, each preview image corresponding to each image may be updated with the header information. In some embodiments, rather than updating each preview image with the header information, each preview image may be updated with an arrow, check box, bullet point or some visual demarcation to indicate that the header information will be present when the image is printed at the imaging device.

At any rate, process 700 continues at block 708, where the activated imaging device command is provided to an imaging device. In at least one of the various embodiments, the activated imaging device command may be provided to an imaging device that is enabled to print, fax, project, display, present, or update an image that is associated with the provided imaging device command. In some embodiments, the remote control device may provide the activated imaging device command to the imaging device. In some embodiments, a device other than the remote control device may provide the imaging device command to the imaging device. In some embodiments, the imaging device may be imaging device 200 of FIG. 2. In some embodiments, the imaging device may be an imaging device that generated a preview image associated with the provided imaging device command.

In some embodiments, the remote control device may provide the activated imaging device command to at least one other imaging device. In at least one embodiment, more than one imaging device command may be provided to the imaging device. The imaging device command may be provided as a command line command or formatted as any suitable data type. The provided command may include arguments, flags, variables, or any modifiers formatted as any suitable data type.

Process 700 then continues to decision block 710, where a determination may be made whether or not another imaging device command is selectively activated by the user of the remote control device. If the user has activated another imaging device command, process 700 may loop back to decision block 704; otherwise process 700 may return to a calling process to perform other actions.

FIG. 8 illustrates a logical flow diagram generally showing one embodiment of a process for employing an imaging device to perform a provided imaging device command. In some embodiments, process 800 or portions of process 800 of FIG. 8 may be implemented by and/or executed by at least one or more imaging devices, such as imaging device 200 of FIG. 2. In some embodiments, process 800 or portions of process 800 of FIG. 8 may be implemented by and/or executed by at least one or more client devices, such as client device 300 of FIG. 3. However, embodiments are not so limited and various combinations of imaging devices and client devices, or the like may be utilized.

Process 800 begins, after a start block, at block 802, where an activated command, such as an imaging device command, may be provided to an imaging device. The imaging device command may be selectively activated by a user of a remote control device. In some embodiments, the remote control device where the imaging device command was activated provides the imaging device command to the imaging device. In some embodiments, another device provides the activated imaging device command to the imaging device. In some embodiments, more than one imaging device command may be provided to the imaging device.

Process 800 then proceeds to decision block 804, where a determination may be made whether or not to provide a copy of the imaging device command to another imaging device. If a copy of the imaging device command is to be provided to another imaging device, process 800 flows to block 806; otherwise process 800 flows to block 808. In some embodiments, this determination may be based on user credentials, user profile information, or user settings for the user of the remote control device. In some embodiments, this determination may be based on settings at the imaging device. In at least one embodiment, this determination may be based on settings at the other imaging device.

In at least one of the various embodiments, this determination may be based on the imaging device command provided to the imaging device. For instance, one imaging device command that may be provided to an imaging device may indicate to provide a copy of either a current, a previous, or a forthcoming imaging device command to at least one other imaging device. This imaging device command may additionally indicate the at least one other imaging device for which to provide a copy of the other imaging device commands to.

At block 806, a copy of the imaging device command provided at block 802, may be provided to another imaging device. In some embodiments, a copy of an image that is associated with the imaging device command may also be provided to the other imaging device. A copy of the imaging device command may be provided to more than one other imaging device. In some embodiments, the imaging device provides the imaging device command to the other imaging device. In at least one of the various embodiments, a remote control device provides the imaging device command to the other imaging device. In at least one embodiment, another device provides the imaging device command to the other imaging device. In some embodiments, the copy of the imaging device command is performed by the other imaging device.

Process 800 next proceeds to block 808, where the provided imaging device command may be performed at the imaging device. Performing the imaging device command may access one or more capabilities of the imaging device, including, but not limited to, printing, faxing, projecting, displaying, presenting, updating, generating, or rearranging at least one image at the imaging device. The image may be associated with the imaging device command. In at least one embodiment, the operation of more than one imaging devices to present a representation of an image may be enabled.

Process 800 proceeds to decision block 810, where a determination is made whether to update the image. If the image is to be updated, process 800 proceeds to block 812; otherwise process 800 proceeds to decision block 818. The image to be updated may be an image associated with the imaging device command. This determination may be based, at least in part on the imaging device command. This determination may be based, at least in part on at least one imaging device capability associated with the imaging device command. Furthermore, this determination may be based, at least in part on user credentials, user profile information, or software settings.

At block 812, an image may be updated. In at least some embodiments, updating the image may be based on performing the imaging device command. The image to be updated may be associated with the imaging device command. Updating the image may be based, at least in part on at least one imaging device capability corresponding with the imaging device command.

For instance, the image may be updated to include a watermark, a page number, a highlight, a bullet point, or other such inclusions. Additionally, the image may be updated to be color corrected. Non-limiting examples of other imaging device capabilities are discussed in relation to block 408 of FIG. 4.

In some embodiments, more than one image may be updated. In at least one embodiment, multiple images may be re-arranged. In some embodiments, multiple images may be re-ordered. In at least one embodiment, updating the image may include printing, faxing, projecting, displaying, or otherwise presenting the image. In some embodiments, a new image may be generated at the imaging control device. In at least one embodiment, the image may be updated at the imaging device. In some embodiments, the image may be updated at another device. The updated image may be cached, or otherwise stored at the imaging device.

Process 800 next flows to decision block 814, where a determination is made whether to update the preview image at the imaging device. If the preview image is to be updated, process 800 flows to block 816; otherwise process 800 flows to decision 818. This determination may be based, at least in part on the provided imaging device command. In some embodiments, this determination may be based on the updated image of block 812. This determination may be based, at least in part on user credentials, user profile information, or software settings.

At block 816, a preview image may be updated and the updated preview image may be provided to the remote control device. In some embodiments, the preview image may be updated at the imaging device. In at least one embodiment, the preview image may be updated at another device. In some embodiments, the updated preview image may be associated with the performed imaging device command. In some embodiments, the updated preview image may be a preview image of the updated image of block 812. Updating the preview image may be based on at least one of the imaging device command, the updated image, or a capability of the imaging device. In some embodiments, updating the preview image may be based in part on user credentials, user profile information, or software settings. In some embodiments, a new preview image may be generated at the imaging device. For instance, if the updated image of block 812 is updated to include a page number, an associated preview image of the image may be updated to also include the same page number. The updated preview image may be cached, or otherwise stored at the imaging device.

The updated preview image may be provided to the remote control device. In some embodiments, the newly generated preview image may be provided to the remote control device. In some embodiments, the updated preview image is provided to the remote control device that provided the imaging device command to the imaging device in block 802. In at least one embodiment, the updated preview image may be provided to another client device. In some embodiments, the updated preview image may be provided to more than one remote control device. In at least one embodiment, the updated image may be cached, or otherwise stored at the remote control device.

At decision block 818, a determination is made whether to update a document. If the document is to be updated, process 800 flows to block 820; otherwise process 800 flows to decision block 822. This determination may be based, at least in part on the imaging device command. This determination may be based, at least on part on at least one imaging device capability associated with the imaging device command. This determination may be based, at least in part on user credentials, user profile information, or software settings. In some embodiments, this determination may be based, at least in part on the document to be updated.

At block 820, a document may be updated based on the performed imaging device command. In some embodiments, the document updated corresponds with the image updated in block 812. Updating the document may be based, at least partially on the updated image at block 812. In some embodiments, updating the document may be based, at least partially on the update preview image of block 816.

In at least one embodiment, the document is updated at the imaging device. In at least one embodiment, the document is updated at another device. In at least one embodiment, a new document is generated at the imaging device. In some embodiments, the updated document may be provided to another device. For instance, if the updated image of block 812 is updated to include a page number, a page of the document corresponding to the updated image may be updated to also include the same page number.

At decision block 822, a determination is made whether another imaging device command is provided to the imaging device. If another imaging device command is provided to the imaging device, process 800 may loop back to decision block 804; otherwise process 800 may return to a calling process to perform other actions.

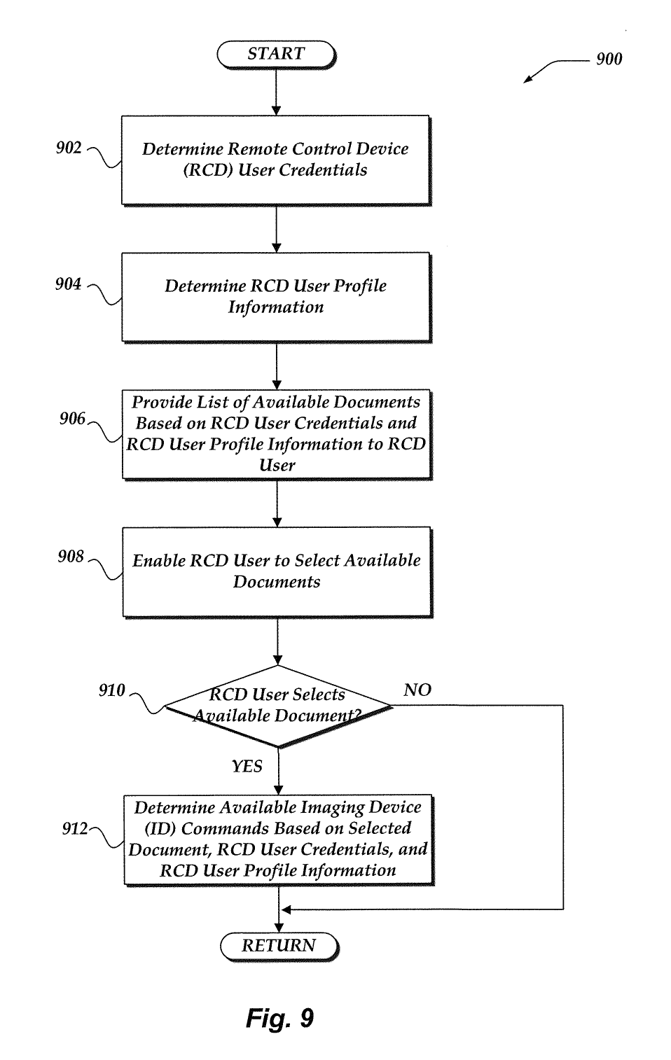

FIG. 9 illustrates a logical flow diagram generally showing one embodiment of a process for remotely controlling imaging devices employing preview images. In some embodiments, process 900 or portions of process 900 of FIG. 9 may be implemented by and/or executed by at least one or more imaging devices, such as imaging device 200 of FIG. 2. In some embodiments, process 900 or portions of process 900 of FIG. 9 may be implemented by and/or executed by at least one or more client devices, such as client device 300 of FIG. 3. However, embodiments are not so limited and various combinations of imaging devices and client devices, or the like may be utilized.

Process 900 begins, after a start block, at block 902, where remote control device user credentials are determined for a user of a remote control device. In some embodiments, the user credentials may be determined based at least in part on a user provided name and password. In some embodiments, the user may provide the name and password by entering them into a GUI on the remote control device, such as the GUI displayed in block 606 of FIG. 6. The remote control device may provide the user credentials to the imaging device. In at least one embodiment, the user may provide other or additional authentication data. In some embodiments, the user may enter the authentication data in some other device. In at least one embodiment, the user credentials are provided to the imaging device.

At block 904, remote control device user profile information may be determined for the user of the remote control device. In some embodiments, the user profile information may be determined at the remote control device. In some embodiments, the user profile information may be determined at another device, such as the imaging device. The user profile information may include information relating to at least user preferences, user geographic location, and user's imaging device history, as well as any other relevant data pertaining to the user.

At block 906, a list of available documents for their selective presentation by the imaging device may be provided to the remote control device. In some embodiments, the list of available documents may be based on at least user credentials determined in block 902. In some embodiments, the list of available documents may be based at least on user profile information determined at block 906. In at least one of the embodiments, at least one of the available documents may be accessed by the imaging device. In some embodiments, at least one of the documents, or a copy of the document, may be stored on the imaging device. In some embodiments, at least one of the available documents may be stored on another device. At least one of the available documents may be accessed by the remote control device. In some embodiments, at least on of the available documents may be stored on one of the remote control devices.

At any rate, process 900 proceeds to block 908, where the user of the remote control device is enabled to select one of the available documents. In some embodiments, the user may be enabled to select more than one of the available documents. In some embodiments, the user may be enabled to select an available document by interacting with a GUI, such as one displayed at the remote control device in a process, or a portion of a process, depicted in block 606 of FIG. 6.

Process 900 proceeds to decision block 910, where a determination is made whether the user of the remote control device selects an available document. If the user selects an available document, process 900 flows to block 912; otherwise process 900 may return to a calling process to perform other actions.

At block 912, available imaging device commands are determined. The process to determine available imaging device commands in block 912 may be similar to the process describe in relation to block 604 of FIG. 6. In addition, determining the available imaging device commands may be based at least partly on the document, or an attribute of the document, determined to have been selected by the user in decision block 910. In some embodiments, determining the available imaging device commands may be base at least in part on the user credentials determined in block 902. In at least one of the various embodiments, determining the available imaging device commands may be based at least in part on the user profile information determined in block 904.

After block 912, process 900 may return to a calling process to perform other actions.

### Use Case Illustrations

Various embodiments of the invention will now be described in the context of three use case scenarios.

Use Case Scenario #1

An office worker uses a special purpose remote control application on their tablet computer, which displays a GUI on the tablet and connects to a multi-function printer (MFP). The application enables the user to browse available documents within a secure “hold and print” queue. By interacting with the GUI, the worker selects a print job and enters user authentication data. The MFP generates a preview image of the first page of the document associated with the print job. The generated preview image is provided to the tablet computer and displayed within the GUI.

The worker verifies the selected print job is the correct print job. The user interacts with the GUI to activate an MFP command which when performed by the MFP, will add a watermark to each image of the print job. The user activates another MFP command, by interacting with the GUI, which when performed by the MFP, will release the print job to print. The remote control application provides the selected MFP commands to the MFP. The MFP performs the provided commands, including updating the associated images to be printed with a formatted watermark and instructing the MFP to print the updated images, including the watermarks.

Use Case Scenario #2

A salesman has a presentation stored on his smart phone. The presentation includes multiple slides. The salesman intends to display the presentation using an associate's projector. The salesman utilizes a remote control application running on his smart phone to provide the presentation document to the projector. The application provides the presentation document to the projector, as well as a projector command to begin the presentation. The projector generates a thumbnail preview image for each slide included in the presentation. The projector provides each of the generated thumbnail preview images to the smart phone.

Within a GUI, provided by the remote control application, the salesman re-arranges the order of the provided thumbnail preview images on his smart phone. By re-arranging the order, a projector command is activated that when performed by the projector, will re-arrange the order of the slides included in the presentation, to an order corresponding with the re-ordered preview thumbnail images. The remote control application provides the activated projector commands to the projector. The projector performs the provided projector commands and the presentation is updated to be in the order defined in the provided projector commands.

During the presentation, to draw attention to a bullet on the current slide, the salesman taps a corresponding bullet on the corresponding thumbnail preview image displayed within the GUI on his smart phone screen. The preview thumbnail image is updated to highlight the bullet. By tapping the bullet, the salesman activates a corresponding projector command. The remote control application provides the activated projector command to the projector. The projector performs the command and the projected image is updated, in real time, to highlight the bullet currently projected.

Use Case Scenario #3

A graphic designer connects to a photo printer running an “http sever” using a standard web browser running on the designer's desktop computer. The printer provides a UI to the browser that enables the designer to provide a color image to the printer. Upon being provided the image, the printer generates an accurate color preview image of the provided image. The printer provides the generated color preview image to the web browser, as well as a UI that allows the designer to selectively activate printer commands, that when performed by the printer, will apply various color corrections to the image provided by the graphic designer.

Each color correction command activated by the designer is provided to the printer. For each provided color correction command, the printer performs the color correction command and generates a color preview image. The printer provides each newly generated color preview image to the web browser. The web browser displays each newly provided generated color preview image to the designer so that the designer may review the effect of each color correction of the image to be printed.

The designer selects the most preferred color correction by clicking on the corresponding provided color preview image and activates a print command by clicking on a print button in the browser. The selected color correction command and the print command are provided to the printer. The printer performs the provided color correction command, which updates the image to be printed to be color corrected in the style that is preferred by the designer. The printer then prints the color corrected by image by performing the provided print command.

The above specification, examples, and data provide a complete description of the composition, manufacture, and use of the invention. Since many embodiments of the invention can be made without departing from the spirit and scope of the invention, the invention resides in the claims hereinafter appended.

What is claimed is:

1. A method for controlling an imaging device (ID) with a remote device (RD) over a network, comprising the actions of:
employing the ID to generate at least one image and at least one preview image of a provided document;
employing the ID to provide the at least one preview image and at least one available command to the RD, wherein the at least one available command is based on at least one of an attribute of the document and a capability of the ID;
employing the RD to display the preview image and the at least one available command, wherein activation of the at least one available command enables at least one operation of the ID to present at least one representation of the image; and
employing the ID to present the at least one representation of the image based on at least one selective activation of the at least one available command at the RD.

2. The method of claim 1, further comprising updating the at least one preview image based on the at least one selective activation of at least one available command at the RD.

3. The method of claim 1, wherein the at least one selective activation of the at least one available command at the RD, further comprises enabling at least one operation of a plurality of IDs to present the at least one representation of the image.

4. The method of claim 1, further comprising:
providing a list of documents to the RD for their selective presentation by the ID based on at least a credential of a user;
enabling the user to select at least one document from the list; and
determining available commands based on at least one credential.

5. The method of claim 1, wherein the ID includes at least one of a printer, a projector, fax, or a monitor.

6. The method of claim 1, further comprising establishing a secure session for communication between the ID and the RD.

7. The method of claim 1, further comprising updating the at least one of the document and the image based on the at least one selective activation of at least one available command at the RD.

8. An imaging device (ID) that is remotely operable by a remote device (RD) over a network, comprising:
a memory device that is arranged to store at least instructions and data;
a presentation device that is operable to present representations of documents; and
a processor device that is operable to execute instructions that enable actions, including:
generating at least one image and at least one preview image of a provided document;
providing the at least one preview image and at least one available command to the RD, wherein the at least one available command is based on at least one of an attribute of the document and a capability of the ID;
enabling the RD to display the preview image and the at least one available command, wherein activation of the at least one available command enables at least one operation of the ID to present at least one representation of the image; and
presenting the at least one representation of the image based on at least one selective activation of the at least one available command at the RD.

9. The ID of claim 8, further comprising updating the at least one preview image based on the at least one selective activation of at least one available command at the RD.

10. The ID of claim 8, wherein the at least one selective activation of the at least one available command at the RD, further comprises enabling at least one operation of a plurality of IDs to present the at least one representation of the image.

11. The ID of claim 8, further comprising:
providing a list of documents to the RD for their selective presentation by the ID based on at least a credential of a user;
enabling the user to select at least one document from the list; and
determining available commands based on at least one credential.

12. The ID of claim 8, wherein the ID includes at least one of a printer, a projector, fax, or a monitor.

13. The ID of claim 8, further comprising establishing a secure session for communication between the ID and the RD.

14. The ID of claim 8, further comprising updating the at least one of the document and the image based on the at least one selective activation of at least one available command at the RD.

15. A computer readable non-transitive storage media that includes instructions for controlling an imaging device (ID) with a remote device (RD) over a network, comprising the actions of:
employing the ID to generate at least one image and at least one preview image of a provided document;
employing the ID to provide the at least one preview image and at least one available command to the RD, wherein the at least one available command is based on at least one of an attribute of the document and a capability of the ID;
employing the RD to display the preview image and the at least one available command, wherein activation of the at least one available command enables at least one operation of the ID to present at least one representation of the image; and
employing the ID to present the at least one representation of the image based on at least one selective activation of the at least one available command at the RD.

16. The media of claim 15, further comprising updating the at least one preview image based on the at least one selective activation of at least one available command at the RD.

17. The media of claim 15, wherein the at least one selective activation of the at least one available command at the RD, further comprises enabling at least one operation of a plurality of IDs to present the at least one representation of the image.

18. The media of claim 15, further comprising:
providing a list of documents to the RD for their selective presentation by the ID based on at least a credential of a user;
enabling the user to select at least one document from the list; and
determining available commands based on at least one credential.

19. The media of claim 15, wherein the ID includes at least one of a printer, a projector, fax, or a monitor.

20. The media of claim 15, further comprising establishing a secure session for communication between the ID and the RD.
